(19) United States
(12) Patent Application Publication
(10) Pub. No.: US 2024/0001476 A1
(43) Pub. Date: Jan. 4, 2024

(54) WELD CABLE GUIDE

(71) Applicant: Illinois Tool Works Inc., Glenview, IL (US)

(72) Inventors: Logan Matthew VandeCorput, Freedom, WI (US); Nathan Joe Jochman, Neenah, WI (US)

(21) Appl. No.: 17/854,900

(22) Filed: Jun. 30, 2022

(51) Int. Cl. B23K 9/32; B23K 9/133

(52) U.S. Cl. CPC B23K 9/32; B23K 9/133

(57) ABSTRACT

Disclosed welding systems include an enclosure comprising a welding-type output port and welding-type conversion circuitry configured to output welding-type power to the welding-type output port. The enclosure defines one or more apertures on an exterior of the enclosure and adjacent the welding-type output port. The welding system further includes a cable guide coupled to the enclosure via the one or more apertures and configured to direct a cable coupled to the welding-type output port.

### FIELD OF THE DISCLOSURE

This disclosure is directed generally to welding systems and, more particularly, to a cable guide of a welding system.

### BACKGROUND

Conventionally, welding systems are contained within a metal enclosure that provides environmental protection for the equipment and provides a safety, sound, and aesthetic barrier for the operators. Welding cables may be coupled to the welding system through the enclosure.

### SUMMARY

A cable guide of a welding system, substantially as illustrated by and described in connection with at least one of the figures.

### BRIEF DESCRIPTION OF THE DRAWINGS

The features of the present disclosure will best be understood from a detailed description of the invention and a preferred embodiment thereof selected for the purposes of illustration and shown in the accompanying drawings.

FIG. 1 is a perspective view of an example welding system including a plurality of cable guides.

FIG. 2 is a block diagram of the example welding system of FIG. 1.

FIG. 3A is an enlarged perspective view of the welding system including the cable guides and a cable. FIG. 3B is an enlarged front view of the welding system including the cable guides, with one of the covers removed to illustrate a welding-type output port.

FIGS. 4A-4B are a front view and a perspective view, respectively, of the cable guide.

FIG. 5A is an enlarged cross-sectional view of the front surface of the enclosure defining a first aperture configured to receive the cable guide. FIG. 5B is an enlarged side view of the front surface of the enclosure defining the first aperture. FIG. 5C is an enlarged front view of the front surface of the enclosure defining the first aperture and a second aperture configured to receive the cable guide. FIG. 5D is an enlarged perspective view of the front surface of the enclosure defining one or more channels.

The figures are not necessarily to scale. Where appropriate, similar or identical reference numbers are used to refer to similar or identical components.

### DETAILED DESCRIPTION

Welding systems, which generate and output welding-type power, are typically within an enclosure. Such welding systems couple to one or more weld cables. In some conventional welding systems, the enclosure includes integrated strain reliefs that the weld cables are routed through to direct or reduce strain on the weld cables. In other conventional welding systems, a strain relief component may be attached to the enclosure using various hardware (e.g., mechanical connections such as bolts, screws, etc.). In yet other conventional welding systems, there may be no strain relief components to direct the strain on the weld cables.

The welding system disclosed herein includes weld cable guides that route weld cables coupled to the weld system. Routing the weld cables may direct and reduce strain on the weld cables and/or welding-type output ports of the welding system that the weld cables are coupled to. Thus, the welding system disclosed herein and/or weld cables used with the welding system disclosed herein may have a longer useful life than a conventional welding system. Moreover, the weld cable guides are not integrated in the enclosure and do not require any additional hardware to couple the weld cable guide to the enclosure. In this way, welding systems including the disclosed weld cable guides may require less hardware, may be easier to assemble, and may be more aesthetically pleasing than conventional welding systems. Additionally, or alternatively, the welding systems disclosed herein may be able to have a less cumbersome, more aesthetically pleasing enclosure as compared to conventional welding systems that have an enclosure with integrated strain relief components.

Although the disclosure is described with respect to a welding system, other systems or devices may benefit from the advantages of the weld cable guides described herein. Thus, the disclosure is in no way limited to for use with welding systems. For example, a system including cables other than weld cables may benefit from the cable guides as described herein.

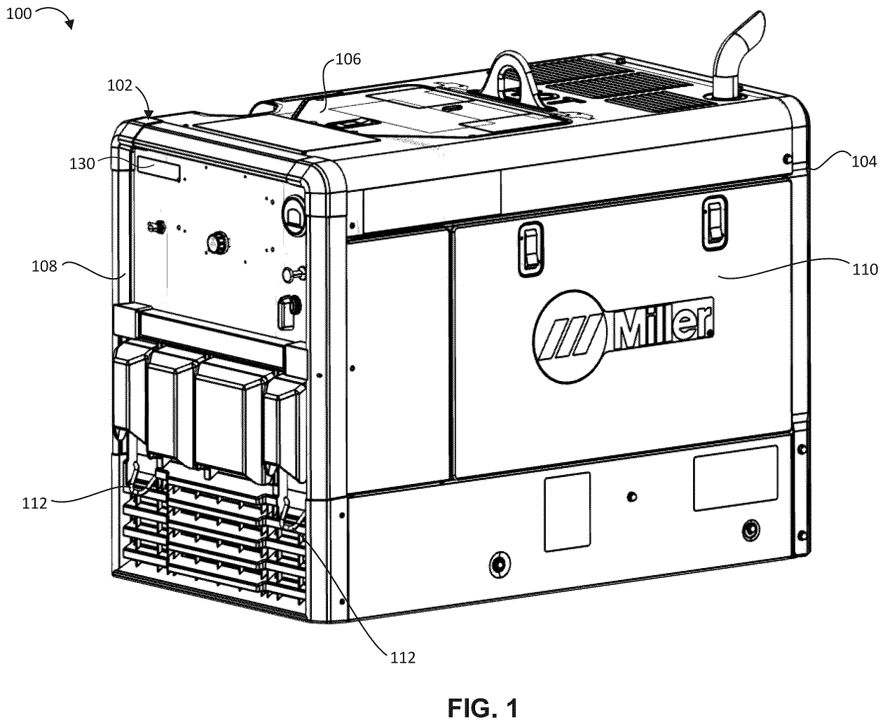

FIG. 1 is a perspective view of an example welding system 100 including a plurality of cable guides 112. The welding system 100 may be used for welding support. In some examples, the welding system 100 may additionally or alternatively be used for various applications, such as, for example, providing compressed air, generating power, and/or pumping. As illustrated in FIG. 1, the welding system 100 includes an enclosure 102. The enclosure 102 protects internal components of the welding system 100 from the environment, as well as providing a safety, sound, and aesthetic barrier for an operator using or within range of the welding system 100. The enclosure 102 is primarily constructed with sheet metal, and may include multiple panels. For example, the enclosure 102 may include the rear surface 104, a top surface 106, a front surface 108, and side surfaces 110 when installed in a predetermined orientation (e.g., when the welding system 100 is installed in accordance with the welding system's 100 intended use). One or more of the rear surface 104, the top surface 106, the front surface 108, or the side surfaces 110 may include multiple panels. One or more of the panels may be removable and/or one or more of the panels may open, to permit access. In other examples, one or more surfaces may include a single, unitary panel.

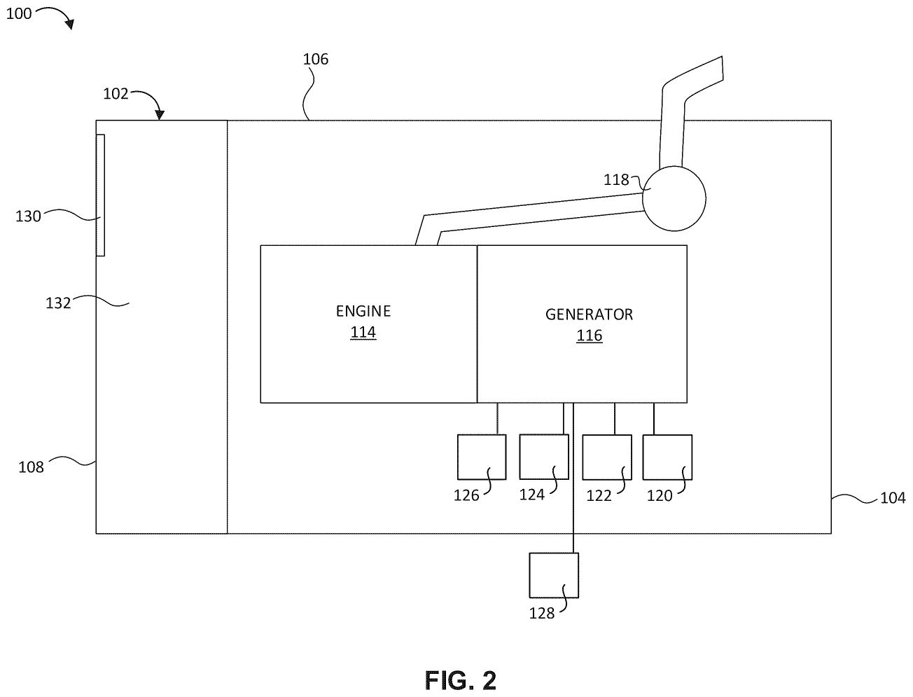

FIG. 2 is a block diagram of the example welding system 100 of FIG. 1. The example welding system 100 may include other components not specifically discussed herein, or may omit one or more of the components discussed herein. The components of the welding system 100 may be arranged within the enclosure 102 in any suitable configuration. The example welding system 100 of FIG. 2 is an engine-driven welding system. The system 100 includes an engine 114 that drives a generator 116 to generate electrical power. The engine 114 may be an internal combustion engine, a diesel engine, a fuel cell, etc. The engine 114 is configured to output mechanical power to drive the generator 116. The engine 114 receives fuel from a fuel tank.

In some examples, the welding system 100 includes one or more power subsystems. For example, the generator 116 may provide the electrical power to welding-type conversion circuitry 120 configured to output welding-type power to a welding-type output port, an air compressor 122 configured to output pneumatic power, a hydraulic pump 124 configured to output hydraulic flow, auxiliary power conversion circuitry 126 configured to output AC power and/or DC power (e.g., DC and/or AC electrical output(s)), and/or any other load device. The example hydraulic pump 124 and the air compressor 122 may be powered by mechanical power from the engine 114 and/or by electrical power from the generator 116.

In some examples, an external power supply subsystem 128 may be coupled (e.g., plugged in, hardwired, etc.) to the welding system 100 to convert at least one of the AC power or the DC power from the auxiliary power conversion circuitry 126 and/or the generator 116 to at least one of AC power or DC power, such as to power external devices that have different power requirements. The example external power supply subsystem 128 may also be communicatively coupled to control circuitry 132 of the welding system 100 (e.g., wirelessly, via power line communication, via a communication cable, etc.) to enable the control circuitry 132 to control the demand and/or output of the external power supply subsystem 128.

The welding-type conversion circuitry 120 converts output power from the generator 116 (e.g., via the intermediate voltage bus) to welding-type power based on a commanded welding-type output. The welding-type conversion circuitry 120 provides current at a desired voltage to an electrode and a workpiece via welding-type output ports to perform a welding-type operation. The welding-type conversion circuitry 120 may include, for example, a switched mode power supply or an inverter fed from an intermediate voltage bus. The welding-type conversion circuitry 120 may include a direct connection from a power circuit to the output port (such as to the weld studs), and/or an indirect connection through power processing circuitry such as filters, converters, transformers, rectifiers, etc.

The auxiliary power conversion circuitry 126 converts output power from the generator 116 (e.g., via the intermediate voltage bus) to AC power (e.g., 120 VAC, 240 VAC, 50 Hz, 60 Hz, etc.) and/or DC power (e.g., 12 VDC, 24 VDC, battery charging power, etc.). The auxiliary power conversion circuitry 126 outputs one or more AC power outputs (e.g., AC outlets or receptacles) and/or one or more DC power outputs (e.g., DC outlets or receptacle). The welding system 100 enables multiple ones of the power subsystems (e.g., the hydraulic pump, the air compressor 122, the welding-type conversion circuitry 120, the auxiliary power conversion circuitry 126, the external power supply subsystem 128, etc.) to be operated simultaneously.

In some examples, the welding system 100 includes a user interface 130. The user interface 130 includes an input device configured to receive inputs selecting mode(s) representative of welding-type processes, mode(s) representative of one or more battery charging modes, mode(s) representative of a vehicle load, and/or other modes such as a pneumatic load and/or a hydraulic load.

The welding system 100 includes an exhaust system 118. In some examples, the exhaust system 118 includes a muffler and a tail pipe. The exhaust system 118 is configured to release exhaust gases from the engine 114 external to the enclosure 102 and reduce the sound of the engine 114 during operation.

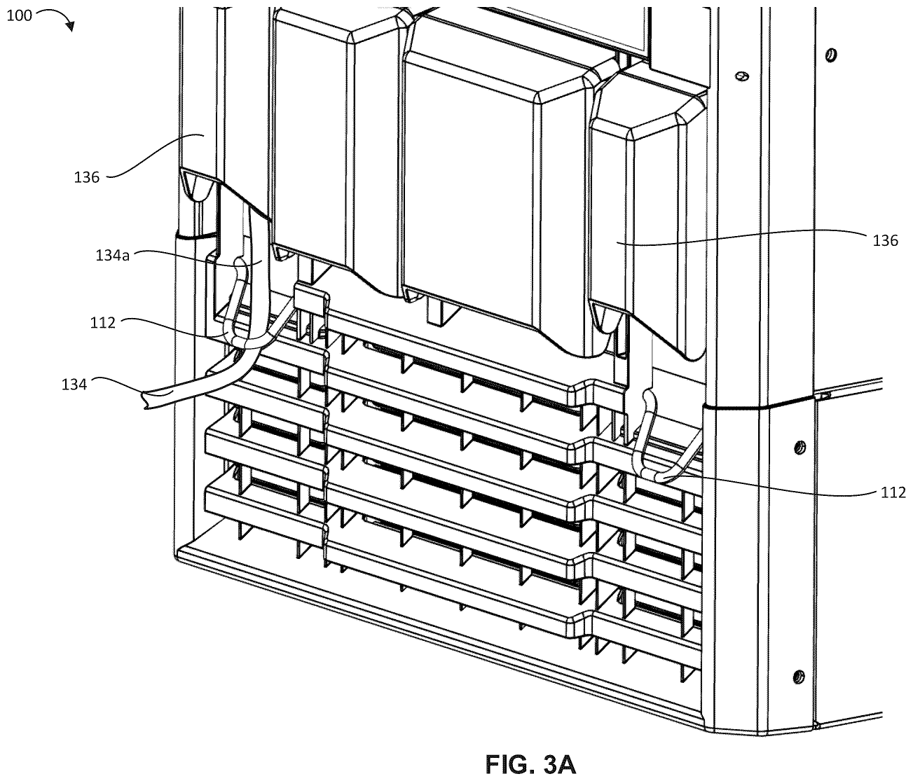

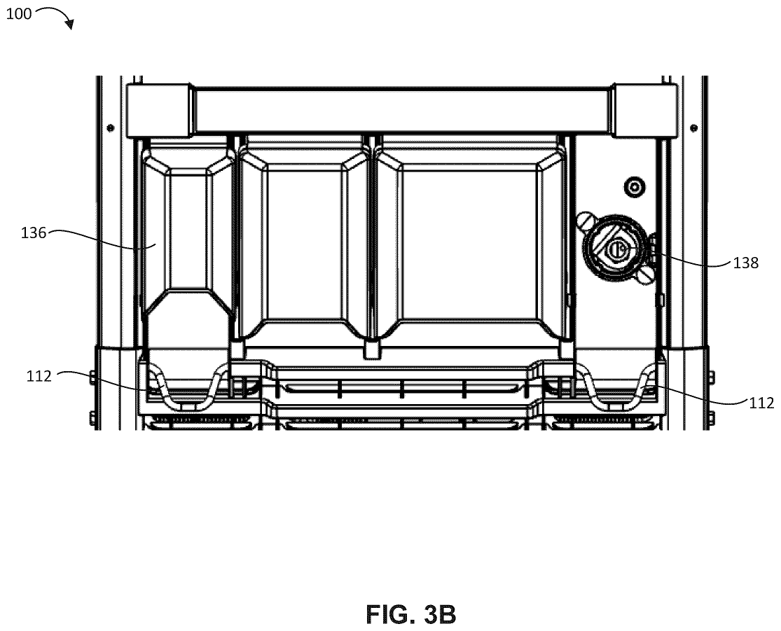

FIG. 3A is an enlarged perspective view of the welding system 100 including the cable guides 112 and a cable 134. FIG. 3B is an enlarged front view of the welding system 100 including the cable guides 112, with one of the covers 136 removed to illustrate a welding-type output port 138. The cable guide 112 may be on an exterior of the enclosure 102 and adjacent to the welding-type output port 138. As seen in FIG. 3A, the cable guide 112 is configured to receive the cable 134. In some examples, the cable 134 may be a welding-type cable. In other examples, the cable 134 may be a different type of cable.

The cable guide 112 is configured to direct the cable 134 attached to the welding system 100. The cable guide 112 may direct and/or reduce strain on the cable 134 or on a welding-type output port 138 (as illustrated in FIG. 3B). For example, in some cases, a cable 134 may have reduced strength and/or a reduced resistance to strain in one direction and have a higher strength and/or higher resistance to strain in another direction. As one example, a cable 134 may have a higher resistance to strain in a direction in which the conductors of the cable are attached to the welding system 100 (e.g., a cable clamp or other connector) and a lower resistance to strain in directions at an angle to the direction in which the conductors of the cable are attached to the welding system 100. In other examples, the differences in resistance to strain may be in other directions.

In some examples, the cable guide 112 may restrain the cable 134 (or at least a portion 134a of the cable 134 between the welding-type output port 138 and the cable guide 112) to angles between about 0 degrees and about 30 degrees from the higher-strength direction (e.g., vertical in the example of FIG. 3A). For example, the cable guide 112 may restrain the cable 134 (or at least a portion 134a of the cable 134 between the welding-type output port 138 and the cable guide 112) to angles between about 0 degrees and about 15 degrees from the higher-strength direction (e.g., vertical in the example of FIG. 3A). In this way, the cable guide 112 reduces strain in the lower-strength direction by at least partially absorbing the strain on the cable 134 and/or by directing the strain to the higher-strength direction of the cable 134. Such a configuration may result in less wear and tear of the welding-type output port 138 and/or the cable 134. In turn, the useful life of the cables 134 and/or the welding system 100 may be increased.

In some examples, the enclosure 102 (e.g., the front surface 108 of the enclosure 102) includes one or more covers 136 (e.g., door, cap, top, etc.). In some such examples, the covers 136 may be configured to conceal the welding-type output ports 138. In other examples, the covers 136 may conceal a different type of outlet port, an inlet port, a power outlet, a button, a switch, or any other component on the front surface 108 of the enclosure 102. In some examples, the covers 136 are pivotably attached to the front surface 108 of the enclosure 102 to enable access to the welding-type output ports 138. In other examples, the covers 136 may be attached to the front surface 108 in a different manner. For example, the covers 136 may be configured to snap onto the front surface 108, slide along the front surface 108, clip onto the front surface 108, or the like. In some examples, the covers 136 may be removably attached to the front surface 108.

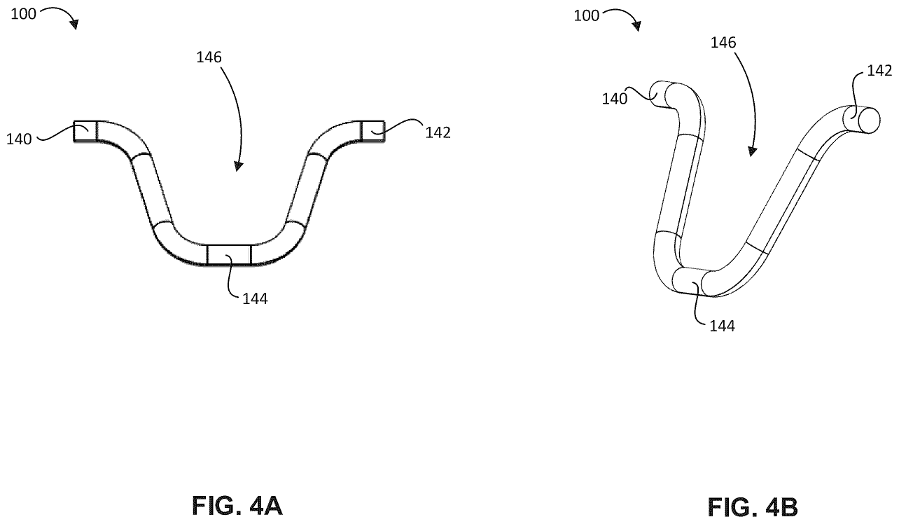

FIGS. 4A-4B are a front view and a perspective view, respectively, of the cable guide 112. The cable guide 112 may have any suitable shape. In some examples, the cable guide 112 includes a first end 140, a second end 142, and a body portion 144 (e.g., between the first and second ends 140, 142). In some examples, such as the example illustrated in FIGS. 4A-4B, the body portion 144 may be a curved body portion. In other examples, the body portion 144 may be a different shape. For example, the body portion 144 may have sharper corners than the curved body portion 144 illustrated in FIGS. 4A-4B or may be more circular in shape. The cable guide 112 may be any suitable size to receive the cable 134. For example, the cable guide 112 may be large enough to receive the cable 134 within the space 146 defined by the body portion 144.

The first and second ends 140, 142 are configured to be received in the front surface 108 of the enclosure 102 to couple the cable guides 112 to the enclosure 102. The first and second ends 140, 142 may define any suitable cross-section. In some examples, as illustrated in FIG. 4B, the first and second ends 140, 142 may define a circular cross-section. In other examples, the first and second ends 140, 142 may define a cross-section with a different shape, such as, for example, an ellipse, a triangle, a square, a rectangle, or another polygonal or rounded shape. In some examples, a cable guide 112 with first and second ends 140, 142 that define a rounded shaped cross-section (e.g., circular or elliptical) may enable the cable guide to pivot (as discussed in more detail below) more easily than a cable guide 112 with first and second ends 140, 142 that define a polygonal cross-section. Moreover, although the cable guide 112 is illustrated with the first and second ends 140, 142 extending outward relative to the body portion 144 (e.g., away from space 146), in other examples the first end 140 and/or the second end 142 may extend inward toward the body portion 144 (e.g., toward space 146).

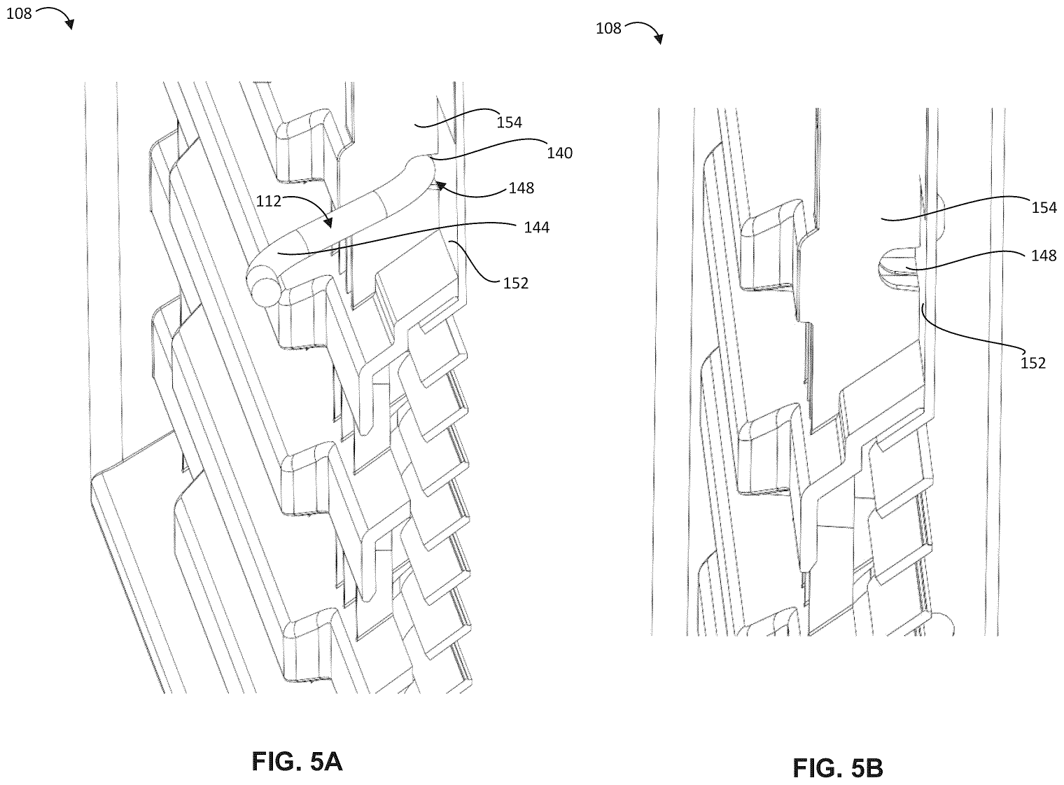

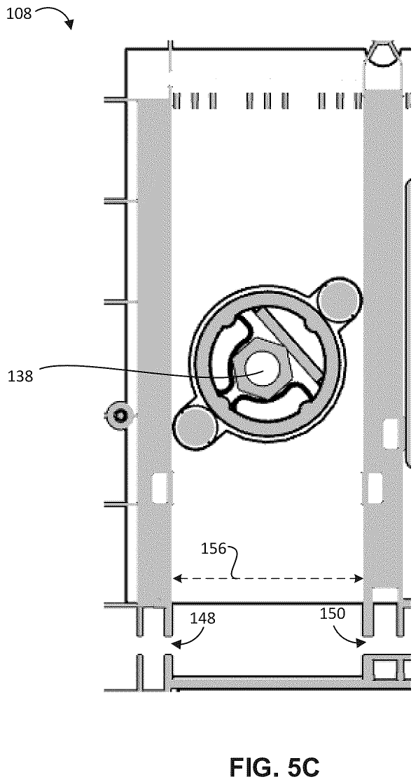

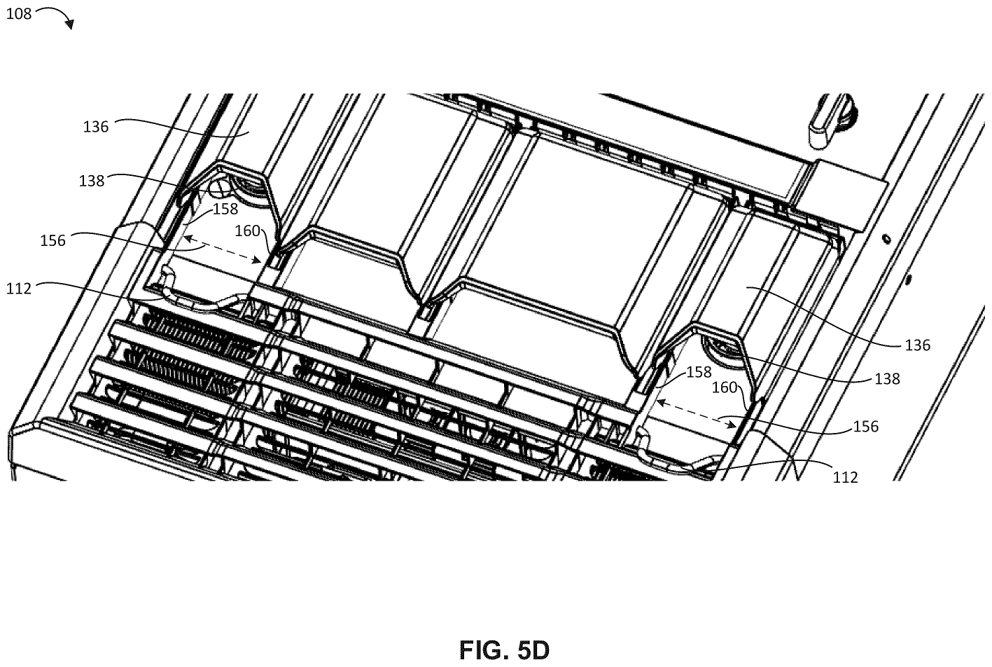

FIG. 5A is an enlarged cross-sectional view of the front surface 108 of the enclosure 102 defining a first aperture 148 configured to receive the cable guide 112. FIG. 5B is an enlarged side view of the front surface 108 of the enclosure 102 defining the first aperture 148. FIG. 5C is an enlarged front view of the front surface 108 of the enclosure 102 defining the first aperture 148 and a second aperture 150 configured to receive the cable guide 112. FIG. 5D is an enlarged perspective view of the front surface 108 of the enclosure 102 defining a channel. In the examples of FIGS. 5B-5C, the cable guide 112 is removed for clarity.

The front surface 108 includes at least one aperture 148 configured to receive the first or second end 140, 142 of the cable guide 112. In some examples, the front surface 108 defines a first aperture 148 and a second aperture 150 configured to receive the cable guide 112. For example, the first aperture 148 may be configured to receive the first end 140 of the cable guide 112 and the second aperture 150 may be configured to receive the second end 142 of the cable guide 112. Although described herein as a first aperture 148 receiving the first end 140 and a second aperture 150 receiving the second end 142 to couple the cable guide 112 to the enclosure 102, in other examples other configurations of cable guides and/or apertures may be used to couple the cable guide to the enclosure 102. For example, in some cases, a single aperture may be configured to receive both ends 140, 142 of the cable guide 112 to couple the cable guide 112 to the enclosure 102.

As discussed above, the cable guide 112 disclosed herein is coupled to the enclosure 102 without the use of hardware such as screws, bolts, or other mechanical fasteners. Instead, the cable guide 112 is configured to be received in one or more apertures 148, 150. In other words, the cable guide 112 is coupled to the enclosure 102 only by the first end 140 being received in the first aperture 150 and the second end 142 being received in the second aperture 152. In this way, the cable guides 112 disclosed herein require less hardware than conventional cable guides. In turn, the disclosed cable guides 112 may be less expensive and easier to install than conventional cable guides.

The first and second apertures 148, 150 may be any suitable shape and size to receive the first and/or second ends 140, 142 of the cable guide 112. In some examples, the first and second apertures 148, 150 may be large enough to allow the cable guide 112 to rotate when received in the first and/or second apertures 148, 150. A cable guide 112 that is able to rotate when received in the first and second apertures 148, 150 may have improved strain relief properties as compared to cable guides that are not rotatable (e.g., conventional cable guides that are integrated in an enclosure). For example, rotation of the cable guide 112 may enable the cable guide 112 to move (to some extent) with the cable 134 which may result in less harsh pulling forces on the cable 143 and may make it easier for a user to move the cable 134 and/or perform welding operations using the welding system 100. Additionally, or alternatively, a rotatable cable guide 112 may enable the cable guide 112 to be rotated out of place (e.g., closer to the surface of the front panel 152) when not in use.

In some examples, the front surface 108 of the enclosure 102 includes a front panel portion 152 and a bezel portion 154. In some such examples, the first and second apertures 148, 150 are defined at an interface of the front panel portion 152 and the bezel portion 154 of the front surface 108. For example, one or both of the front panel portion 152 or the bezel portion 154 may include one or more cut outs that define the first or second aperture 148, 150 when the front panel portion 152 and the bezel portion 154 are adjacent to each other to define the front surface 108 of the enclosure 102. As one example, the bezel portion 154 illustrated in FIGS. 5A-5B includes a cut out that defines the aperture 148 when the bezel portion 154 is adjacent to the front panel portion 152. In examples in which both the bezel portion 154 and the front panel portion 152 include cut outs to define one of the apertures 148, 150, the cut outs may substantially align when the bezel portion 154 and the front panel portion 152 are adjacent to each other as the front surface 108 of the enclosure 102.

In some examples, the cable guide 112 and the enclosure 102 are separate components. For example, in some cases, the cable guide 112 may be resiliently deformable such that the cable guide 112 can be installed in the first and second apertures 148, 150 after installation of the bezel portion 154 and the front panel portion 152 of the front surface 108 to the welding system 100. In other examples, the cable guide 112 may be installed in the enclosure 102 when the bezel portion 154 and the front panel portion 152 are installed. For example, the cable guide 112 may be installed between the front panel portion 152 and the bezel portion 154 (e.g., sandwiched between) during installation. In some examples, the cable guide 112 may be installed in the front surface 108 without the use of tools or without use of additional hardware (e.g., screws, bolts, etc.). In this way, welding systems including the disclosed weld cable guides 112 are may require less hardware, may be easier to assemble, and may be more aesthetically pleasing than conventional welding systems. Additionally, or alternatively, in some cases, the cable guide 112 may be removably coupled to the enclosure 102.

In some examples, the front surface 108 may define a channel 156. For example, the front panel portion 152 of the front surface 108 may define the channel 156. Additionally, or alternatively, the bezel portion 154 may define the channel 156. In examples in which the front surface 108 defines the channel 156 the first and second apertures 148, 150 may be on opposite sides of the channel 156. For example, the channel 156 may be defined by a first wall 158 and a second wall 160 of the bezel portion 154 and/or the front panel portion 152. In such examples, one of the first aperture 148 or the second aperture 150 may be along the first wall 158 and the other of the first aperture 148 or the second aperture 150 may be on along the second wall 160 of the channel 156. In this way, the cable guide 112 is positioned within the channel 156 when the first and second ends 140, 142 of the cable guide 112 are received within the first and second apertures 148, 150. In some examples, the body portion 144 of the cable guide 112 may not extend outside of the channel 156. For example, a width of the body portion 144 of the cable guide 112 may be less than a width of the channel 156.

As illustrated herein, the welding system 100 includes two cable guides 112. In some such examples, a first cable guide 112 may be coupled to the enclosure 102 via the first and second apertures 148, 150 adjacent a first welding-type output port 138 and a second cable guide 112 may be coupled to the enclosure 102 via third and fourth apertures 148, 150 adjacent a second welding-type output port 138. The cable guides, welding-type output port, and apertures may be the same or substantially the same, so different sets of cable guides, welding-type output ports, and apertures are not described individually herein. Moreover, in other examples, the welding system 100 may include any number of cable guides 112, such as, for example, one, two, three, or four or more cable guides.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A welding system comprising:
an enclosure comprising a welding-type output port, wherein the enclosure defines one or more apertures on an exterior of the enclosure and adjacent the welding-type output port;
welding-type conversion circuitry configured to output welding-type power to the welding-type output port; and
a cable guide coupled to the enclosure via the one or more apertures and configured to direct a cable coupled to the welding-type output port.

2. The welding system of claim 1, wherein the one or more apertures comprises a first aperture and a second aperture on an exterior of the enclosure and adjacent the welding-type output port.

3. The welding system of claim 2, wherein the cable guide comprises a first end and a second end, and wherein the cable guide is coupled to the enclosure only by the first end being received in the first aperture and the second end being received in the second aperture.

4. The welding system of claim 3, wherein the cable guide comprises a curved body portion between the first end and the second end.

5. The welding system of claim 1, wherein no hardware is required to couple the cable guide to the enclosure.

6. The welding system of claim 2, wherein the enclosure comprises a front panel portion and a bezel portion, and wherein the first and second apertures are defined at an interface of the bezel portion and the front panel portion.

7. The welding system of claim 6, wherein one of the front panel portion or the bezel portion comprises a channel, the first and second apertures are on opposite sides of the channel, and the cable guide is positioned within the channel.

8. The welding system of claim 6, wherein the cable guide is resiliently deformable for installation into the first aperture and the second aperture after installation of the bezel portion and the front panel portion.

9. The welding system of claim 6, wherein the cable guide is installed during installation of the bezel portion and the front panel portion.

10. The welding system of claim 1, wherein the cable guide is removably coupled to the enclosure.

11. The welding system of claim 2, further comprising a second cable guide coupled to the enclosure via a third aperture and a fourth aperture of the enclosure adjacent a second welding-type output port, the second cable guide configured to direct a second cable coupled to the second welding-type output port.

12. The welding system of claim 1, wherein the cable guide is rotatably coupled to the enclosure.

13. The welding system of claim 1, wherein the enclosure and the cable guide are separate components.

14. The welding system of claim 1, wherein the one or more apertures comprises a single aperture adjacent the welding-type output port and configured to receive a first end and a second end of the cable guide.

15. The welding system of claim 1, further comprising one or more of, within the enclosure:
an engine;
a generator configured to convert mechanical power to electrical power;
an air compressor configured to output compressed air;
a hydraulic pump configured to generate hydraulic flow; or
auxiliary power conversion circuitry configured to convert the electrical power to at least one of AC output power or DC output power.
